(19) United States
(12) Patent Application Publication
(10) Pub. No.: US 2007/0289023 A1
(43) Pub. Date: Dec. 13, 2007

(54) Mobile Game Download to a Cellular Phone Via a Down Load Module by an Internet Access

(76) Inventors: Bjorn Bunte, Unna (DE); Janne P. Salminen, Helsinki (FI); Peter Decker, Marl (DE); Harry Santamaki, Helsinki (FI); Jukka Kansanaho, Tyrnava (FI); Nouri Allahwerdi, Helsinki (FI); Pirkko Taskinen, Oulu (FI); Frank Zillikens, Essen (DE)

Correspondence Address: MORGAN & FINNEGAN, L.L.P., 3 WORLD FINANCIAL CENTER, NEW YORK, NY, 10281-2101, US

(21) Appl. No.: 10/591,368

(22) PCT Filed: Jun. 16, 2004
(86) PCT No.: PCT/IB04/02001

§ 371 Date: May 18, 2007

(30) Foreign Application Priority Data
Mar. 1, 2004 (IB) PCTIB2004000522

(51) Int. Cl. H04L 9/32

(52) U.S. Cl. 726/28

(57) ABSTRACT

The present invention relates to game applications on cellular phone devices. It also relates to a new possibility to reduce the communication load of mobile communication networks for downloading high quality game software to game-enabled cellular phone devices. The present invention further relates to a method and a download device and a game enabled cellular telephone device for downloading game software for a game-enabled cellular phone from a server to said game-enabled cellular phone via a download module and an internet connection. The method of the invention is based on establishing a local connection between said game-enabled cellular phone and said download module, establishing an internet connection between said server and said download module, and starting a game download from said server, via said internet connection and said local connection through said download module to said game-enabled cellular phone.

The present invention relates to game applications on cellular phone devices. It also relates to a new possibility to reduce the communication load of mobile communication networks for downloading high quality game software to game-enabled cellular phone devices. This invention deals with server based game download services and their usage scenario. In this scenario a central server acts as a main distributor for game software to gaming-enabled cellular phones. This invention proposes a novel generic game download module.

Presently, there are different kinds of mobile game devices available. There are e.g. the SEGA™ GAMEGEAR™, the ATARI™ LYNX™, and the commercially successful NINTENDO™ GAMEBOY™. All these devices provide a possibility to play electronic games from an inserted mass memory device storing the game software.

Conventionally, the game devices are not able to download new game software from a server, as said devices require proprietary mass memory devices for storing the game software. These proprietary game software modules represent a significant obstacle for users to copy and distribute contents of these hardware-contained games.

The game performance of game enabled cellular phones is dramatically increasing. For example, the Nokia N-Gage introduces a new way of gaming experience which requires new storage means for the game data. For the N-Gage, the game software technology is actually the multi media card (MMC). For future, even more complex games, the required memory will be even increased to such an extent that the delivery of game content has to focus on new channels.

It is presently known to download e.g. ring tones as is disclosed in the document EP 1246142. This document pertains to a method and a system for creating and presenting an individual audio information program for a mobile phone.

The other prior art solutions, i.e. to deliver the game software as physical media, such as MMC or micro drive, are actually not satisfying.

All the above approaches for mobile wireless multi-player gaming have in common that they are not fully suitable for the downloading of huge game application programs into cellular phone devices, as the data transfer load requires unreasonable download periods. This fact considerably reduces the game experience due to low computing/communicating power or low battery capacity that may not be sufficient to perform a complete download of a complex and extensive high-quality game software program.

It is also desirable to simplify the purchase of a game, and increase the flexibility for game publishers.

It is further desirable to provide a fast and cheap access to huge amounts of digitally coded data to cellular phone devices.

According to a first aspect of the present invention a method for a game software download from a server to a game-enabled cellular phone via a download module (or home gateway) and an internet connection is provided. The method comprises establishing a connection which is preferably local between a game-enabled cellular phone and said download module, establishing an internet connection based or non-cellular internet connection between said games server and said download module, and initiating a game software download from said games server to said game-enabled cellular phone.

The game software download is performed, according to the present invention from said server via said internet connection and via said download module or home gateway to said cellular phone.

The present invention provides an alternative data communication path to a cellular phone. That is, the present invention provides a non-mobile or non-cellular “data bypass” for the downloading of huge amounts of data. This enables a cheap, flexible and unusual approach to fill a mobile cellular terminal with data at low costs.

In this basic version of the method, said connection between a game-enabled cellular phone and said download module or home gateway is established by said cellular phone e.g. upon a user input. The internet connection between said games server and said download module is also initiated in this basic version by the cellular phone controlling the download module.

In an example embodiment of the method of the present invention said establishing of said internet connection comprises setting up an analog telephone line connection. The analog telephone line can be provided by a conventional public switched telephone network (PSTN), or plain old telephone network (POTS), in this case e.g. an auto-dialing enabled modem can be used or the user may have to type in a certain telephone number.

In another example embodiment of the method of the present invention said establishing of said internet connection comprises setting up a digital telephone line connection such as e.g. a Digital Subscriber Line (DSL) or an Integrated Services Digital Network (ISDN) connection.

In yet another example embodiment of the method of the present invention said establishing of said internet connection comprises connecting said download module via a broadband cable connection to said server. This method relies on a data transfer via the broadband cable such as used for cable TV program delivery. This embodiment comprises the connecting of the download module to the broadband cable.

In another example embodiment of the method of the present invention said establishing of said internet connection comprises establishing a powerline communication connection. This embodiment can in the simplest case comprise the connecting of said download module with a powerline modem to a powerline. It is even possible to provide the modem without any switches, flashlight signals and the like.

In yet another additional example embodiment said establishing of said internet connection comprises setting up a glass fiber connection. By using glass fiber connections the present invention can use fast data download rates. If the data download capacity of the glass fiber connection exceeds said data transfer rate from said download modem to said mobile telephone, said download module can spool the data in an internal memory for subsequent e.g. low level data transfer to said mobile telephone.

In another example embodiment said establishing of said internet connection comprises establishing a satellite downlink. In this case the download module is connected to a communication satellite or a TV-satellite receiver, wherein the satellite transfers the data using free communication capacities analogously to the broadband cable in the TV cable data communication.

In yet another example embodiment said establishing of said internet connection comprises setting up an Ultrawideband connection. Ultawideband communication is defined in the IEEE802.XX specification and comprises wireless communication paths such as Wireless local loop (WLL), Wireless Local Area Network (WLAN), Bluetooth and the like.

In another example embodiment said wherein said establishing of said internet connection comprises setting up a line of sight transmission connection. This line of sight transmission connection comprises a laser line of sight transmission connection or the use of a radio relay transmission for directional radio communication.

An example embodiment of the method of the present invention further comprises establishing a connection between said game-enabled cellular phone and said games server via a public land mobile network (PLMN). This embodiment of the present invention provides in a simple way a possibility of a circle transfer or ring transfer. This feature further allows any kind of information ring transfer from the server to the phone for example to initiate the download from the terminal to the phone, wherein the initiation is performed via the cell net and the download is performed via one of the above cited established internet connections.

Another benefit of the “doubled data connection” between the cellular phone resides in a simplified charging option for the download by e.g. the telephone bill of any other charging method usually used for charging conventional internet access. Additionally, the server can be provided with a number of additional information such as the calling cellular phone number, and can be provided with an access to the serial number of the cellular terminal device e.g. for including a digital rights management (DRM). An elegant way to implement DRM feature would be to use a serial number of a storage media. Thereby it can be assured that a user can use an unlimited number of backup copies that can be used only with a single specific mass storage. Thereby, a user can use a single mass storage device with different cellular phones, as long as the specific mass storage is operable. The serial number of the mass storage device may be transmitted via the cellular phone network to the server.

It is also possible to use another identification number of the cellular telephone, thereby enabling the distributor of the game download to prevent that a game application can be started on another terminal without a confirmation of the game provider.

The use of two different data connections can also be used to increase the data transmission speed, if the game software is transferred simultaneously via said internet connection (e.g. said public switched telephone network connection) (via said download module) and via said cellular phone network to said cellular phone.

In another example embodiment of the method of the present invention said connection between said game-enabled cellular phone and said games server via a public land mobile network is used for authentication, authorization and/or payment procedures.

Another elegant way to implement DRM feature would be to use a serial number of the telephone number stored in the subscriber identification member (SIM card) in the cellular phone. Thereby, it can be assured that a user has an unlimited access to the game. A user can use a single mass storage device even on different cellular phones, as long as the user also changes his SIM card. The serial number (or the telephone number) of the SIM card may be transmitted via the cellular phone network to the server.

In yet another example embodiment of the method of the present invention said connection of said game-enabled cellular phone to said download module is initiated by said cellular phone. In this embodiment the telephone is basically the only active connection-initiating element.

In another example embodiment of the method of the present invention said setting up of an internet connection between said download module and said games server is initiated by said cellular phone. That is, the cellular phone establishes the internet connection indirectly via the download module to connect to the server, e.g. by dialing a telephone line network number of the server or an internet provider.

In yet another example embodiment of the method of the present invention said connection between said game-enabled cellular phone and said games server is initiated by said cellular phone. That is, the telephone uses the cellular phone network to connect to the server. This enables a two-path connection to perform e.g. authorization and authentication of the software for e.g. Digital Rights Management (DRM) applications. It is for example possible to transfer a keycode via the PLMN (from the phone to the server or vice versa) while the bulk software download is performed via the internet connection, for example a telephone line.

The two-path download can be used to prevent a multi-terminal download via a single internet connection or a single telephone line. Thus, it can be prevented that an arbitrary number of cellular phones connected to a single internet access point or a single telephone line in parallel receive a game program. This feature can be used to ensure that the game software is delivered to a single recipient only.

In another example embodiment of the method said establishing of said internet connection between said games server and said download module is initiated by said games server. Thereby, the server can provide a kind of call back function to exploit e.g. a reduced internet connection charge or a reduced telephone charge. This can reduce in the case of advertising actions the charge for the download.

In yet another example embodiment of the method of the present invention said connection between said game-enabled cellular phone and said games server via a public land mobile network is initiated by said games server. This represents the inverse option to the above described example embodiment, wherein the server initiates a cellular network call back.

In another example embodiment of the method of the present invention said downloaded game software is stored onto an exchangeable mass storage. By storing the downloaded game software onto an exchangeable mass memory the present invention provides a simple option to use many different games with a gaming device without any necessity to provide excessive storage capabilities in said cellular phone.

In yet another example embodiment of the method of the present invention said establishing of a wireless connection between said cellular phone and said download module or home gateway is performed according to a Bluetooth protocol. Other possible protocols are for example the wireless local area network (W-LAN) protocol, the WLL protocol or any other IEEE 802.XX protocol. It is also possible to use a wired connectivity such as IEEE 1394 or the universal serial bus (USB).

In another example embodiment of the present invention said method further comprises transferring or selecting of setting data, (such as addresses, upload/download data rates, packet size, repetition rates, fragmentation, coding, scrambling . . . ) from said game-enabled cellular phone to said download module. It is also possible to transfer or select the data transfer settings data from said game-enabled cellular phone to said server (e.g. via said download module or said PSTN or any of the other cited download module server connections). It is also possible to select or transfer the setting data from said server to said game-enabled cellular phone (e.g. via said download module or said PSTN).

According to yet another aspect of the invention, a software tool is provided comprising program code means for carrying out the method of the preceding description when said program product is run on a computer or a network device.

According to another aspect of the invention, a computer program product is provided comprising program code means stored on a computer readable medium or being downloadable from a communication network for carrying out the methods of the preceding description, when said program product is run on a computer or a network device. This can be embodied e.g. as a mass storage device for the use in a wireless cellular gaming device, comprising only an initialization engine and a game communication control engine.

According to another aspect of the present invention a download module or a game software gateway is provided. Said download module comprises an internet communication interface and a cellular phone communication interface. The download module represents an interface or gateway device to connect a game-enabled cellular phone (such as e.g. N-Gage) to the internet. The download module can be provided without a dedicated user interface. The application arranging the download of game software may run on the game cellular phone. This download application may use a broadband connection of the download module to download the game software. The download module can also be provided with an internal memory. The game can either be stored temporarily on the download module (e.g. a hard disk) or can directly be downloaded to the game enabled cellular phone. The technology for the connection between the home device and the game enabled cellular phone is again either wireless or wired.

In an example embodiment said internet communication interface comprises an analog telephone line interface. When provided with an analog telephone line interface for a conventional public switched telephone network PSTN the download module can access any kind of conventional telephone networks.

In another example embodiment of said download module said internet communication interface comprises a digital telephone line interface. Thereby modem digital communication phone techniques such as Digital Subscriber Line (DSL) or Integrated Services Digital Network (ISDN) can be employed for faster and more convenient data downloads.

In yet another example embodiment said internet communication interface of said download module comprises a broadband cable modem. Thereby the present invention can access a broadband cables such as used for example for cable TV to enable a faster data download parallel to the broadcasting of the TV and radio broadcast program via the cable. It also possible to use a data-only broadband cable for downloading.

In another example embodiment said internet communication interface of said download module comprises a powerline modem. By using powerline modems it is possible to provide the modem without any switches, flashlight signals and the like, when e.g. the modem is powered by connecting it to the powerline an may be remotely controlled by a connected mobile phone not even a power switch is necessary for operation.

In one example embodiment said download module is incorporated into a charging unit of the mobile telephone. This embodiment has the advantage that a download can be initiated during a time period the cellular phone is not in use (during a charging operation). This embodiment can be used for example in the case of powerline modems to provide a simple and easy to use download module, the download module can be connected to the mobile phone via a data and power bus line or bus contact.

In another embodiment of said download module said internet communication interface comprises a glass fiber connection modem. This embodiment enables fast downloads via a glass fiber connection even of large amounts of data.

In yet another example embodiment said internet communication interface comprises a satellite receiver. The use of a satellite downlink in the area of data downloads is performed analogously to the internet access and data download via broadband cable networks. It is also possible to use dedicated communication satellites.

In another example embodiment said internet communication interface of said download module comprises an ultrawideband transceiver device. The ultrawideband comprises the IEEE802.XX type wireless radio standards such as Wireless local loop (WLL), Wireless Local Area Network (WLAN) and Bluetooth.

In yet another example embodiment said internet communication interface comprises a line of sight transmission transceiver. In case of a line of sight transceiver it may be noted that the transceiver may be remotely arranged in relation to the download module. The line of sight transceiver may be implemented as a laser or a radio relay transmission device. Radio relay transmission devices are known from e.g. from directional radio communication.

In another example embodiment of the method of the present invention said download module farther comprises a desktop docking station for a game-enabled cellular phone. The docking station can be provided with a charger unit. The docking station can also be provided with a storage module to backup e.g. downloaded games. By integrating a storage component in the docking station, a user can store currently not needed data such as a recently not used game software in said docking station, thereby reducing the memory requirements of the cellular phone.

According to another aspect of the present invention a game-enabled cellular phone device is provided. Said cellular phone comprises a built-in download module as described in the above sections for providing an internet connection to enable a data download from a server in the internet.

One example embodiment of the present invention provides a cellular telephone that comprises also a conventional wired telephone module. In the embodiment the telephone line module represents a means for connecting said mobile telephone with the internet via conventional telephone internet provider. The telephone module enables the telephone to be used as a conventional phone if and when connected to a telephone line by a connection cable or can serve as a conventional cellular phone if not. The cable can be provided as e.g. a separate cable or as a built-in inertia-reel cellular phone-line cable. The cellular phone of the present invention can also provide a conventional “wired phone” functionality to enable voice transfer via the telephone line as an alternative to cellular voice communication.

A possible implementation is to connect the cellular phone and the conventional phone components in parallel to the low frequency voice band processing components.

According to another aspect of the present invention, the present invention provides a download system. Said download system comprises a download module, a game-enabled cellular phone and game software download server. In the system said game-enabled cellular phone is connected to said download module, and said download module is connected via a “non-cellular” internet connection to said game software download server. The system provides the functionality to perform a download as described in the preceding sections of the specification related to the method of the present invention.

In an example embodiment of the system of the present invention said game-enabled cellular phone is also connected via a cellular phone connection to said game software download server. The system can be implemented with a download device that is located at the home of the user and that is permanently connected to an internet connection such as e.g. a telephone line. The download module may just serve as a gateway without an own dedicated user interface. Preferably, the download module has a broadband Internet connection such as a digital subscriber line (DSL), or an integrated services digital network (ISDN) or for example cable. The game software download server provides a “games download service”. This server can provide the latest games on a trusted digital rights management (DRM) platform to be downloaded.

It is to be noted that the download module can also be provided as a multi access device comprising two or more of the above internet communication paths. It is also to be noted that the internet connection can also comprise a multi carrier connection wherein the download module is indirectly connected via a local area network and e.g. a telephone gateway to the internet.

In the following, the invention will be described in detail by referring to the enclosed drawings in which:

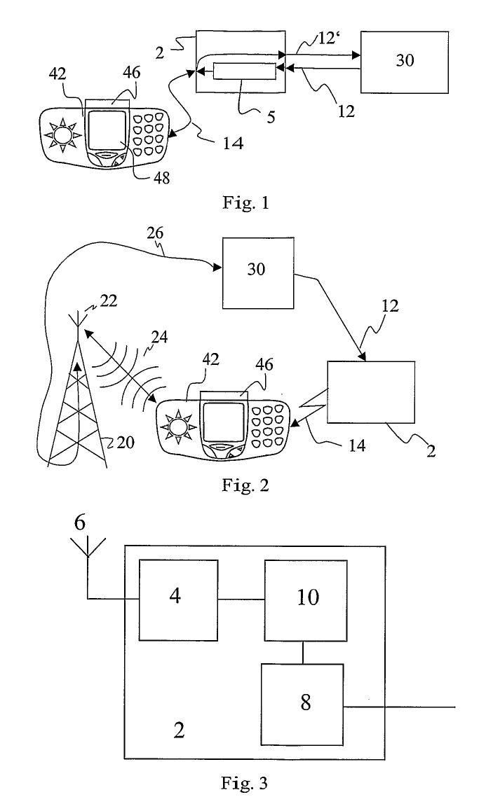

FIG. 1 shows a basic embodiment of a download system module according to an embodiment of the present invention,

FIG. 2 depicts a more sophisticated embodiment of a download system according to another embodiment of the present invention.

FIG. 3 shows a basic embodiment of a download module according to an embodiment of the present invention,

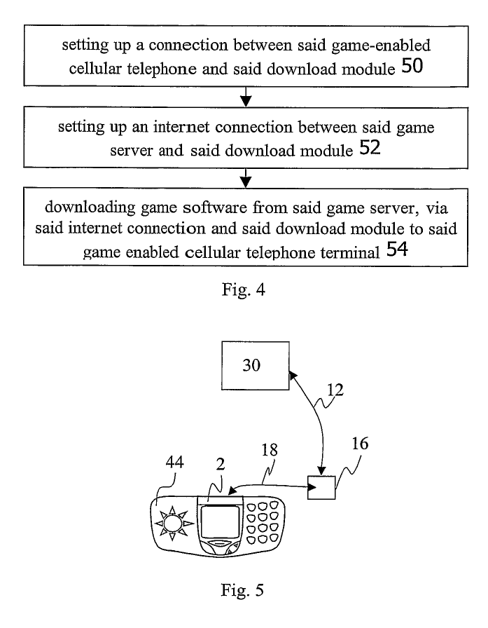

FIG. 4 shows a basic embodiment of a method of the present invention, and

FIG. 5 depicts an embodiment of a cellular phone with a built-in download module according to an embodiment of the present invention.

In the following the present invention will be described in detail by referring to an example embodiment wherein said internet connection is provided only by a telephone line. The other embodiments using different access paths can be achieved by interchanging the telephone line connection by one of the above referenced communication paths.

FIG. 1 shows a basic embodiment of a download system module according to an embodiment of the present invention. The download system comprises a download module 2, a game-enabled cellular phone 42 and a game-software download server 30. The download module 2 is connected to the game-enabled cellular phone 42 by a wireless or by a wired connection 14. The download module 2 is connected to the game-software download server 30 by a telephone line of conventional non-cellular phone network. The download module is connected to the telephone line e.g. by a modem (not shown).

The main data transfer load is expected to occur in download direction 12 from the server to the cellular phone. Only a minor data transfer load is expected to occur in upload direction 12′. To compensate differences in the data transfer rates of the game software and to further compensate transmission delays between the connections 14 and 12, an intermediate memory 5 can be provided in download direction. The intermediate memory 5 may be implemented as a data queue.

In FIG. 1 the cellular phone further comprises an interchangeable mass storage device 46 serving as a memory device to enable a user to change the game software without any data exchange and download periods.

FIG. 2 depicts a more sophisticated embodiment of a download system according to another embodiment of the present invention. In FIG. 2 the download system of FIG. 1 is extended by an additional cellular network connection from the cellular phone 42 to the game software download server 30. The cellular connection is provided by a cellular network connection 26 between the server 30 and the base station 20. The base station 20 is connected via the antenna 22 and an air interface 24 to the cellular phone 42. This configuration provides an improved circular structure to enable improved digital rights management, as the server can always determine the exact number of actually receiving terminal devices.

FIG. 3 shows a basic embodiment of a download module according to an embodiment of the present invention. In FIG. 3 the generic download module 2 is embodied as a data download provider, to connect the cellular phone to a telephone line, therefore the term “module” or “gateway” is used to underline the mainly communicative implementation of the download module.

The implementation is based on two parts. A stand-alone download module 2 may also be provided with enough computational power and can also comprise a memory (not shown). The download module 2 is equipped at least with one wired interface to a telephone line and a wired (like universal serial bus (USB)) or wireless connection means like BT or W-LAN. The download module 2 is equipped with a telephone line communication component 8 and a cellular phone communication component 10 for transferring game software data received from the telephone line to the cellular phone. Both engines require a data exchange protocol. The cellular phone communication component 10 may be connected to a transceiver 4 provided with an antenna 6. It is also possible to implement the transceiver only as a transmitter, in case that the ring communication is used for the game software download.

The protocol for the communication with the server can be any proprietary data download protocol. The protocol can be a standard e.g. Internet protocol designed to be optimized with respect to download time by using a binary protocol. The proposed solution may be used for also accessing the Internet, but may also be implemented in connection with a conventional telephone line server. This implementation may simplify the download of certain game software to a game-enabled cellular phone to dial a predefined number.

The telephone line communication component 8 may be implemented as a modem to connect e.g. the internet via the public switched telephone network (PSTN) to provide an interface to the cellular phone to forward game software and to provide an intermediate memory (or a data queue) for storing downloaded data.

The connection from the cellular phone to the download module can be implemented as a wireless connection (such as Bluetooth, W-LAN, or Infrared) or can be implemented as a wired connection such as USB (universal serial bus).

A memory (not shown in FIG. 3) in the download module 2 can be used to queue the data in case that differences is the data transfer rates of the telephone line communication component 8 and the cellular phone communication component 10 occur. If it is possible to control the data transfer rates with a sufficient accuracy to be equal a memory may be economized, as the data is just directly forwarded.

User interface software (such as an Internet browser) for controlling the download procedure (selecting the game software, transfer of customer data, initiation of the download etc.) can be provided on the download module. The user interface software can also be located on the cellular phone. The cellular phone-based user interface software may be implemented as the standard browser for cellular browsing provided with a customized application program interface, to control the access to the download module.

FIG. 4 shows a basic embodiment of the method according to an embodiment of the present invention. The depicted embodiment comprises the steps of setting up a connection between said game-enabled cellular telephone and said download module 50, followed by setting up a public switched telephone network connection between said game server and said download module 52, and downloading games software from said game server, via said telephone line connection and said download module to said game-enabled cellular telephone terminal 54. Though not explicitly mentioned terminating the download and closing the connections terminates the method.

FIG. 5 depicts an embodiment of a cellular phone 44 with a built-in download module 2 according to an embodiment of the present invention. The download module 2 can be the module of FIG. 3, wherein said transceiver 4 and the antenna 6 are replaced by a direct electric contact device to the cellular phone 44. That is, the present invention provides a cellular telephone 44 that comprises also a conventional wired modem module or even a complete telephone module 2 to enable wired and cellular voice telephony. The phone may be used as a conventional line modem or even as a conventional cellular phone when connected to a telephone line e.g. with a connection cable 18. The connection cable 18 can be provided as e.g. a separate cable or as a built-in inertia-reel cellular phone-telephone-line cable 18. The connection cable 18 is connected to the phone connector 16 providing a pluggable access to the PLTN 12.

A possible implementation is a cellular/line telephone wherein the cellular phone and the conventional phone components are connected in parallel to the low frequency voice band processing components.

A more sophisticated implementation of game-enabled integrated cell-line phone can be provided if the cell-line phone is capable of simultaneously operating the cellular network and the telephone line network.

The settings of the download module may be selectable (i.e. remotely controllable) by said game-enabled cellular phone or by said server. Thereby, the settings of the download module such as e.g. addresses, upload/download data rates, packet size, repeat rate, fragmentation, coding, scrambling...) can be selected from said game-enabled cellular phone or e.g. from said server. Thereby, it is possible to perform a game download without the need for a direct interaction of a user with the download module.

With the present invention it will possible to use even complex games with a storage volume in the order of gigabytes in cellular phones, which may otherwise require the use of hard disk drives in the cellular game telephones for transferring game software from a hard disk into the game enabled cellular telephones storage for game software execution. With the present invention it will be possible to download even highly complex game software to a cellular telephone with justifiable costs, as the immense expense for the retail trade can be economized.

This application contains the description of implementations and embodiments of the present invention with the help of examples. It will be appreciated by a person skilled in the art that the present invention is not restricted to details of the embodiments presented above and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1-50. (canceled)

51. A computer system accessible remotely by a user to authenticate a document, comprising:
a memory configured to store electronic image data corresponding to an original document having a verifiable provenance, and separately derived electronic displayable verification information corresponding to the provenance of at least part of the original document, and
an output configured to provide said image data and said verification information for display by the user to authenticate the original document.

52. A computer system according to claim 51 wherein the image data has been obtained from an authenticated source, and the verification information includes data corresponding to the provenance of the authenticated source.

53. A computer system according to claim 51 wherein data is fed to and from the memory under the control of a repository.

54. A computer system according to claim 53 wherein the verification information comprises data concerning the provenance that has been subjected to authentication by the repository, and the verification information being configured to signal to the user that the repository provides such authentication.

55. A computer system according to claim 52 wherein data stored in the memory cannot be altered by users.

56. A computer system according to claim 53 including apparatus to receive the image data from a remote location.

57. A computer system according to claim 51 including a scanner for scanning an original document to produce said image data.

58. A computer system according to claim 51 including a repository agent including apparatus operable to send image data corresponding to an original image to the repository

59. A computer system according to claim 58 wherein the repository agent is operable to send the image data together with source authentication information to indicate to the repository that the image data has been sent from the agent.

60. A computer system according to claim 51 wherein the verification information comprises predetermined accreditation indicia to be viewed by a user concurrently with the image data for authenticating individual parts of the original document.

61. A computer system according to claim 51 wherein the verification information comprises accreditation data to be viewed by a user in a separate field associated with the image data for authenticating the original document.

62. A computer system according to claim 51 wherein the image data and the verification information are stored in a common electronic file.

63. A computer system according to claim 62 wherein the file is a PDF file.

64. A computer system according to claim 51 including a server providing said memory and operable to host a website at which said image data and verification information is viewable by a user to authenticate the original document.

65. A computer system according to claim 51 wherein said output is connected to the Internet.

66. A computer system according to claim 51 wherein said image data and verification information in the memory is password protected so that the user can only gain access thereto by use of the password.

67. A computer system according to claim 51 wherein the image data and the verification information corresponding to the original document when stored in the memory collectively has an individual addressable identity.

68. A method of operating a computer system according to claim 51, to provide said image data and said verification information for display by the user to authenticate the original document.

69. A method of displaying a document for authentication, comprising:
creating electronic image data corresponding to an original document having a verifiable provenance,
providing electronic, displayable verification information corresponding to the provenance of at least part of the original document, and
displaying the image data and the verification information, to permit a user to authenticate the document.

70. A method according to claim 69 including receiving the image data from an authenticated source, storing the image data for display, and creating the verification information for the received image, wherein the verification information includes data corresponding to the provenance of the authenticated source.

71. A method according to claim 69 including authenticating the source of the image data.

72. A method according to claim 68 including feeding the image data and the verification information to a memory under the control of a repository for display to users wishing to authenticate the original document.

73. A method according to claim 72 wherein only the repository can change the data in the memory.

74. A method according to claim 72 wherein the verification information comprises data concerning the provenance that has been authenticated by the repository.

75. A method according to claim 74 wherein the repository communicates with the source of the image data to determine the provenance thereof and to develop said verification information.

76. A method according to claim 72 including feeding the image data to the repository from a remote location.

77. A method according to claim 72 including sending send image data corresponding to an original image from a repository agent to the repository.

78. A method according to claim 76 including sending the image data together with source authentication information to indicate to the repository that the image data has been sent from the repository agent.

79. A method according to claim 68 including configuring the verification information to include predetermined accreditation indicia viewable concurrently with the image data for authenticating individual parts of the original document by a user that authenticates the document.

80. A method according to claim 68 including configuring the verification information to comprise accreditation data to be viewable by a user in a separate field associated with the image data for authenticating the original document.

81. A method according to claim 68 including storing the image data and the verification information are stored in a common electronic file.

82. A method according to claim 68 including storing the image data and the verification information are stored in a common electronic PDF file.

83. A method according to claim 68 including hosting a website at which said image data and verification information is viewable by a user to authenticate the original document.

84. A method according to claims 18 including authenticating the original document by viewing said electronic image data and the corresponding verification information.

85. A method according to claim 68 wherein said image data and verification information is password protected so that a user can only gain access thereto by use of the password, and including supplying the password to a user to permit the user to authenticate the original document.

86. A method according to claim 68 wherein the image data and the verification information corresponding to the original document collectively have an individual addressable identity and including supplying the individual addressable identity to a user to permit the user to access the data and information for authenticating the original document.

87. A method according to claim 85 including supplying a hyperlink to the user.

88. An electrical signal for displaying a document for authentication to be received by a client computer operated by a user who wishes to authenticate the document, comprising:
electronic image data corresponding to an original document having a verifiable provenance, and
electronic, displayable verification information corresponding to the provenance of at least part of the original document.
